(19) United States
(12) Patent Application Publication
(10) Pub. No.: US 2012/0045276 A1
(43) Pub. Date: Feb. 23, 2012

(54) Twist-lock T-clamp

(76) Inventor: Jeffrey D. Carnevali, Seattle, WA (US)

(21) Appl. No.: 12/806,722

(22) Filed: Aug. 18, 2010

(51) Int. Cl. F16B 7/04

(52) U.S. Cl. 403/350

(57) ABSTRACT

A twist-lock T-clamp formed of a housing having spaced base and crown portions with a keel projected from the base thereof, and an aperture communicating between the base and the crown along an operational axis extending therebetween. An anchor is formed with a pair of opposing flukes extended outwardly therefrom adjacent to one end thereof. The anchor is moveable within the aperture of the housing relative to the operational axis. An axial drive mechanism is coupled between the anchor and the aperture of the housing. The axial drive mechanism is operable for moving the flukes of the anchor between an undeployed installation/removal configuration substantially aligned with the keel and spaced away from the base of the housing, and a deployed interlock configuration substantially crosswise of the keel and adjacent to the base of the housing.

### FIELD OF THE INVENTION

The present invention relates generally to T-clamps for connecting to a T-slot, and in particular to quick release T-clamps having a substantially automatic locking mechanism.

### BACKGROUND OF THE INVENTION

T-clamps for connecting to a T-slot are generally well-known. However, known T-clamps are limited in their ability to efficiently provide quick and reliable interlocking with a T-slot, as well as quick and easy unlocking and disconnecting from the T-slot.

Accordingly, there exists a need for a quick release T-clamp having an efficient assembly and interlocking mechanism, as well as a quick and easy unlocking and disassembly mechanism.

### SUMMARY OF THE INVENTION

The present invention is a novel quick release twist-lock T-clamp having an efficient assembly and interlocking mechanism, as well as a quick and easy unlocking and disassembly mechanism.

According to one aspect of the invention the novel quick release twist-lock T-clamp is formed of a housing having spaced base and crown portions with a keel projected from the base thereof, and an aperture communicating between the base and the crown along an operational axis extending therebetween. An anchor is formed with a pair of opposing flukes extended outwardly therefrom adjacent to one end thereof. The anchor is moveable within the aperture of the housing relative to the operational axis. An axial drive mechanism is coupled between the anchor and the aperture of the housing. The axial drive mechanism is operable for moving the flukes of the anchor between an undeployed installation/removal configuration substantially aligned with the keel and spaced away from the base of the housing, and a deployed interlock configuration substantially crosswise of the keel and adjacent to the base of the housing.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view showing an example of the twist-lock T-clamp for operation with a conventional T-slot;

FIG. 2 and FIG. 3 illustrate installation/removal of the twist-lock T-clamp with a conventional T-slot;

FIG. 4 and FIG. 5 illustrate the twist-lock T-clamp with an anchor portion thereof in an undeployed installation configuration with its flukes configured in an installation orientation;

FIG. 6 and FIG. 7 illustrate the twist-lock T-clamp with its anchor portion in a deployed interlock configuration having its flukes configured in an interlock orientation;

FIG. 8 is an end view of the twist-lock T-clamp having a rudder portion removed for clarity and showing an end view of the flukes configured in an installation orientation;

FIG. 9 illustrate the twist-lock T-clamp with its anchor in the undeployed installation configuration with its flukes in the installation orientation;

FIG. 10 and FIG. 11 illustrate the anchor oriented in subsequent stages of deployment between the undeployed installation configuration and a fully deployed interlock configuration;

FIG. 12 illustrates the twist-lock T-clamp with its the anchor oriented in its fully deployed interlock configuration;

FIG. 13 illustrates an axial drive mechanism of the twist-lock T-clamp;

FIGS. 14-18 illustrate various aspects of the axial drive mechanism.

### DETAILED DESCRIPTION OF PREFERRED EMBODIMENT

In the Figures, like numerals indicate like elements.

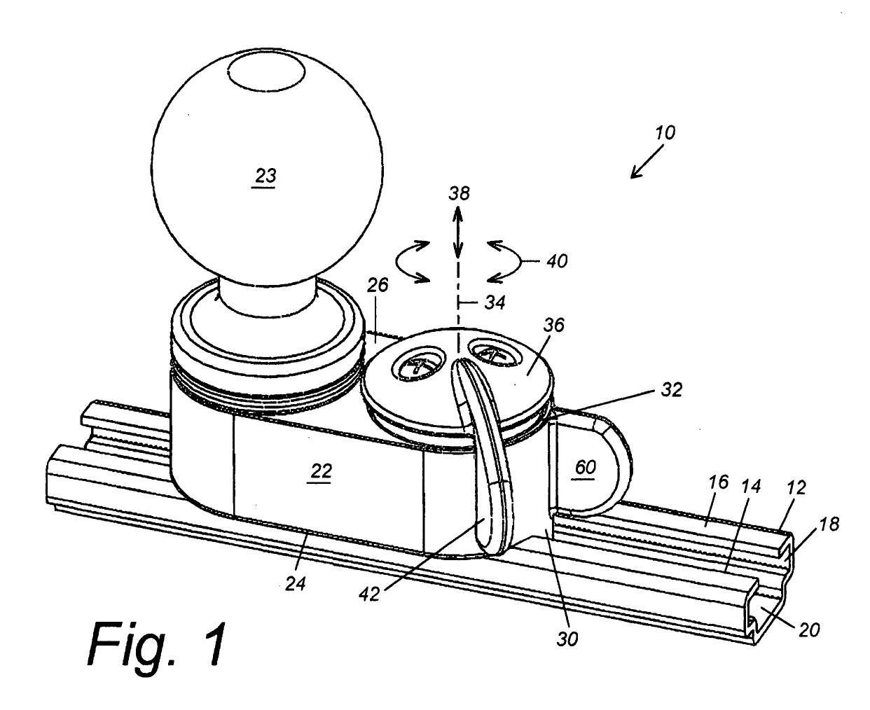

FIG. 1 illustrates one embodiment of a novel twist-lock T-clamp 10 for operation with a conventional T-slot 12 formed in a rail (shown) or other plate. T-slot channel 12 is formed as a T-shaped lengthwise cavity that has an opening 14 to a mounting surface 16 formed between opposing spaced apart T-arms 18 spread out from a shallow stem 20 about the same width as opening 14. T-clamp 10 includes a housing 22 molded of a substantially rigid material, for example, an injection moldable plastic, composite or metal material, and having a mount 23 projected therefrom. Housing 22 of T-clamp 10 is formed with a substantially planar base 24 and a crown 26 spaced away from base 24. A keel 28 is formed along base 24 of T-clamp housing 22 and is sized to be received through opening 14 into T-slot 12 between spaced apart T-arms 18. Optionally, keel 28 may extend into stem 20 of T-slot 12. A rudder 30 is formed on base 24 of T-clamp housing 22 in a position spaced away from keel 28 and is also sized to be received through opening 14 into T-slot 12 between spaced apart T-arms 18. Optionally, rudder 30 also may extend into stem 20 of T-slot 12. T-clamp housing 22 is further formed with an axial bore or aperture 32 communicating between its base 24 and crown 26 along an operational axis 34 passing between keel 28 and rudder 30 of housing 22.

A substantially rigid twist-lock anchor 36 is coupled for motion relative to operational axis 34 extended through T-clamp housing 22 and passing between keel 28 and rudder 30 thereof. Twist-lock anchor 36 is coupled for linear motion (arrow 38) relative to axis 34 responsive to rotational motion (arrow 40) thereof about axis 34. For example, anchor 36 is responsive to operation of a handle or other grip mechanism 42 coupled thereto for rotational motion (arrow 40) about operational axis 34 which results in linear motion (arrow 38) along same axis 34.

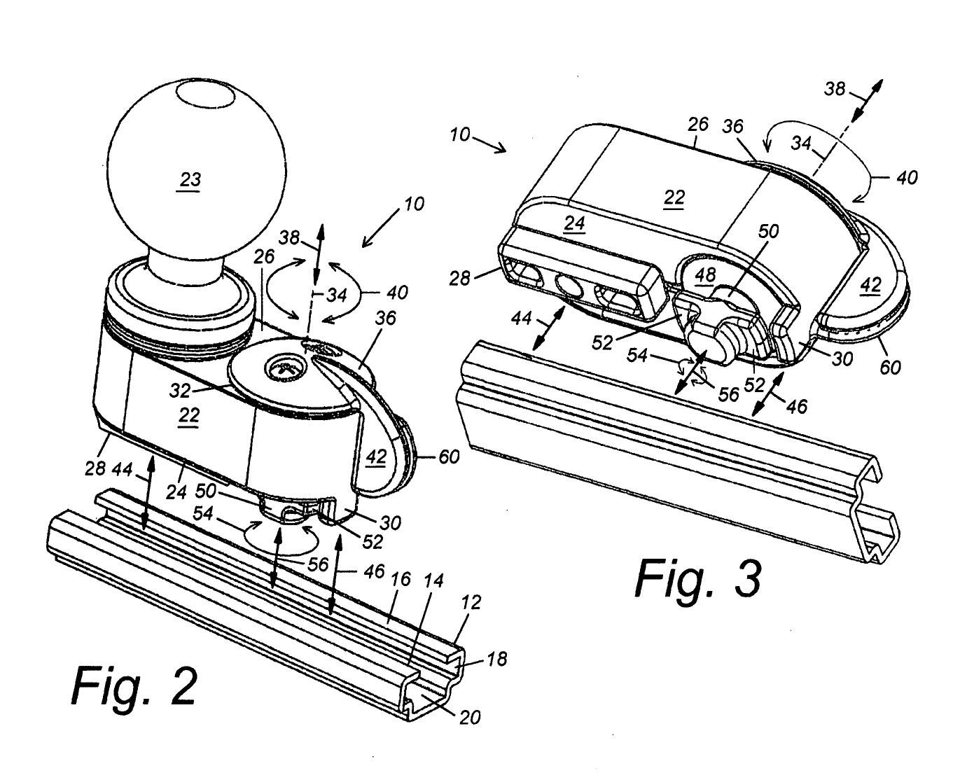

FIG. 2 and FIG. 3 illustrate installation of T-clamp 10 into T-slot 12 and removal therefrom. As illustrated, keel 28 and rudder 30 on base 24 of T-clamp housing 22 are installed into or removed from T-slot 12 along direction (arrows 44, 46) of axis 34. During installation, base 24 of T-clamp housing 22 is brought into contact with mounting surface 16 adjacent to T-slot opening 14. Anchor 36 is formed with a barrel-shaped stock portion 48 having a smaller shank 50 extended therefrom substantially along axis 34. Two or more flukes 52 are rigidly extended outwardly from shank 50 substantially crosswise of axis 34 in positions external of T-clamp housing 22 and substantially diametrically opposite one from the other. Each fluke 52 is sized to be received into T-slot 12 through opening 14 and into opposing T-arms 18 on either side of T-slot stem 20. Flukes 52 are movable in a rotational motion (arrow 54) substantially about axis 34 responsive to rotation (arrow 40) of anchor 36 about axis 34. Additionally, rotation (arrow 40) of anchor 36 causes linear motion (arrow 56) of flukes 52 relatively toward and away from base 24 of T-clamp housing 22 as a function of linear motion (arrow 38) of anchor 36 along axis 34. During installation and removal, each fluke 52 is rotated (arrow 54) into an undeployed configuration (shown) that is substantially aligned between keel 28 and rudder 30 on base 24 of T-clamp housing 22.

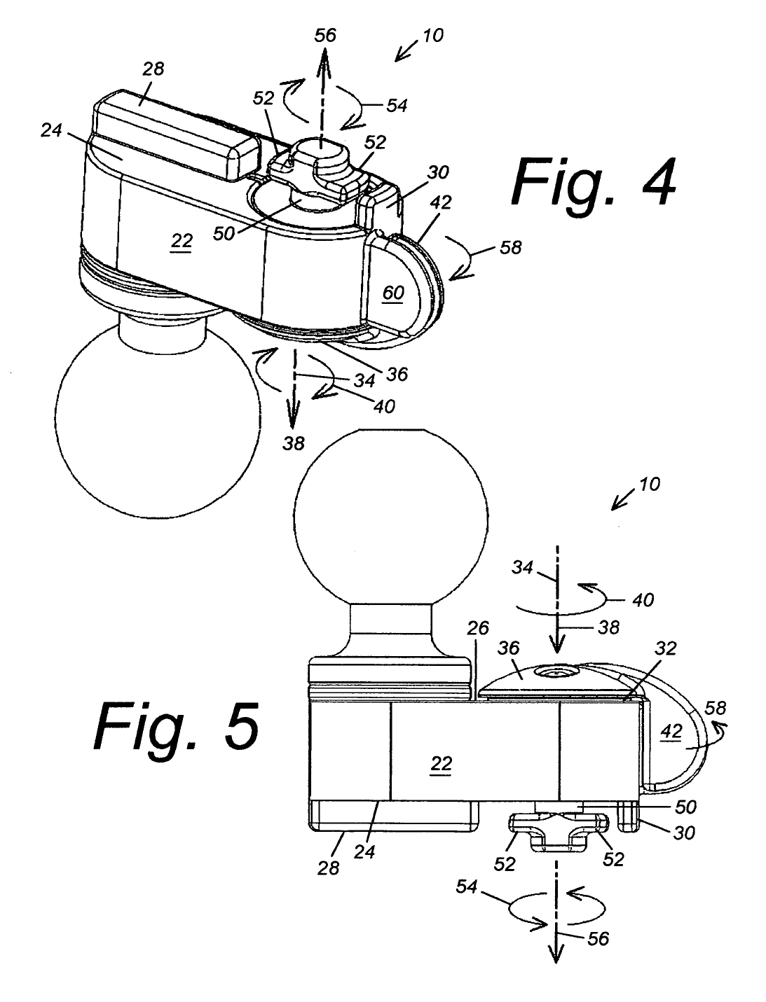

FIG. 4 and FIG. 5 show T-clamp 10 configured in the installation state with flukes 52 of anchor 36 oriented in the undeployed configuration. This relative orientation of anchor 36 and flukes 52 is achieved as a function of an axial drive mechanism by rotation about operational axis 34, as by operation of handle or other grip mechanism 42 coupled thereto. For example, grip 42 is rotated (arrow 58) toward a register 60 formed on T-clamp housing 22. Register 60 effectively stops anchor 36 with flukes 52 oriented in the undeployed configuration for configuring T-clamp 10 in the installation state. Accordingly, this configuration of flukes 52, keel 28, rudder 30 and anchor 36 permits T-clamp 10 to be inserted through opening 14 into T-slot 12 until base 24 of T-clamp housing 22 is seated against mounting surface 16. This same configuration of flukes 52 permits keel 28, rudder 30 and anchor 36 permits T-clamp 10 to be withdrawn through opening 14 for removal from T-slot 12.

Here, keel 28 is embodied as a small pin projected from base 24 of T-clamp housing 22.

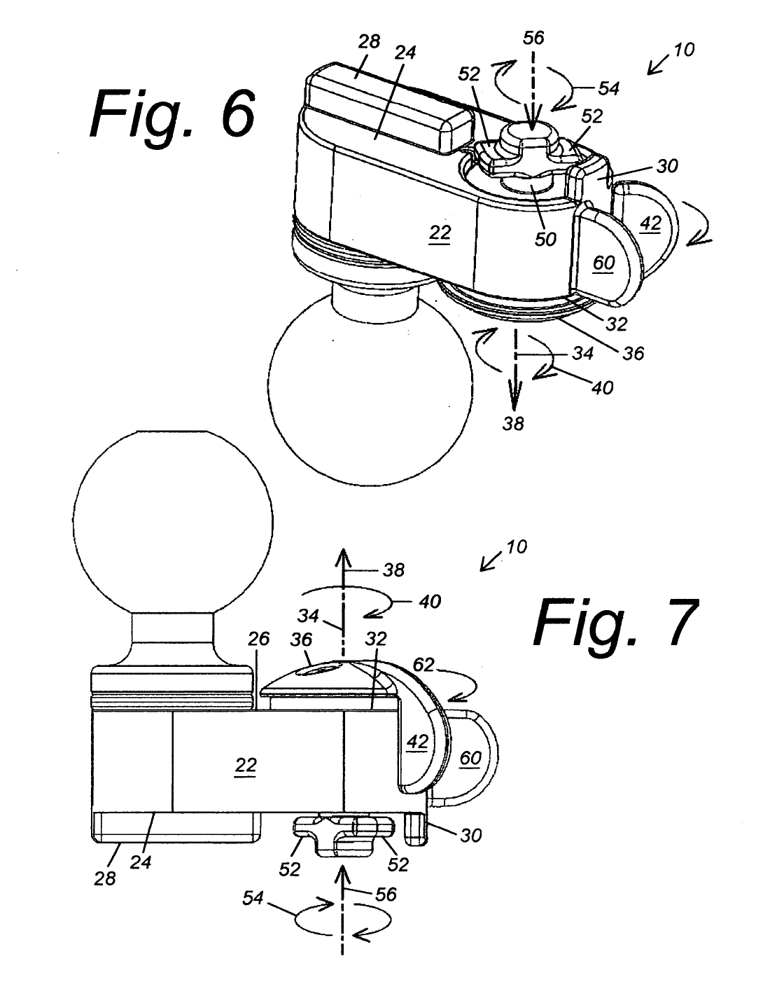

FIG. 6 and FIG. 7 show T-clamp 10 configured in an interlock state with flukes 52 of anchor 36 oriented in a deployed interlock configuration (shown) substantially crosswise of axis operational 34 between keel 28 and rudder 30 and pulled adjacent to base 24 of T-clamp housing 22 along axis 34. This relative orientation of anchor 36 and flukes 52 is achieved as a function of the axial drive mechanism by opposite rotation about operational axis 34, as disclosed herein. For example, grip 42 is rotated (arrow 62) away from register 60 on T-clamp housing 22. Rotation (arrow 62) opposite of installation direction (arrow 54) effectively orients anchor 36 and flukes 52 in the deployed interlock configuration for configuring T-clamp 10 in the interlock state. Accordingly, this configuration of flukes 52, keel 28, rudder 30 and anchor 36 effectively interlocks T-clamp 10 into T-slot 12 with base 24 of T-clamp housing 22 firmly seated against mounting surface 16. This same configuration of flukes 52 permits keel 28, rudder 30 and anchor 36 resists T-clamp 10 withdrawal through opening 14 and removal from T-slot 12.

FIG. 8 is an end view of T-clamp 10 having rudder 30 removed for clarity and showing an end view of flukes 52 of anchor 36. Here, flukes 52 of anchor 36 oriented in the undeployed configuration (shown) substantially aligned with between keel 28 and rudder 30 and spaced away from base 24 of T-clamp housing 22 along operational axis 34. Flukes 52 optionally pitched to include an upper interlock surface 64 that is rotated at a small ramp angle 66 about a fluke axis 67 that is oriented substantially crosswise of operational axis 34 similarly to a fan blade or screw thread. When anchor 36 is rotated (arrow 54) about operational axis 34, a leading edge 68 of each fluke 52 distal from base 24 of T-clamp housing 22 first engages an upper surface 18a of arm 18 of T-slot 12. As rotation of anchor 36 progresses, rotated upper interlock surface 64 continues to engage upper surface 18a of arm 18 drawing base 24 of T-clamp housing 22 closer to mounting surface 16 of T-slot 12, until a trailing edge 70 of fluke 52 adjacent to base 24 of T-clamp housing 22 finally engages upper surface 18a of arm 18. Accordingly, base 24 of T-clamp housing 22 is drawn nearer to mounting surface 16 of T-slot 12 by rotated upper interlock surface 64 during rotation (arrow 54) of anchor 36 between its undeployed installation configuration and its deployed interlock configuration (shown in FIG. 6 and FIG. 7). In the fully deployed interlock configuration of anchor 36, T-clamp 10 is compressively interlocked with T-slot 12 by flukes 52 extended into each of opposing T-arms 18.

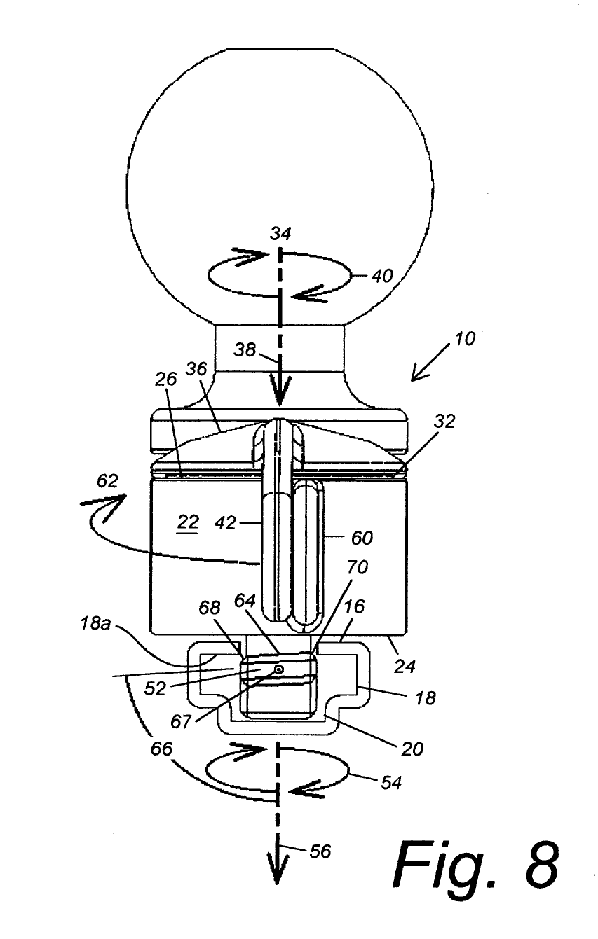

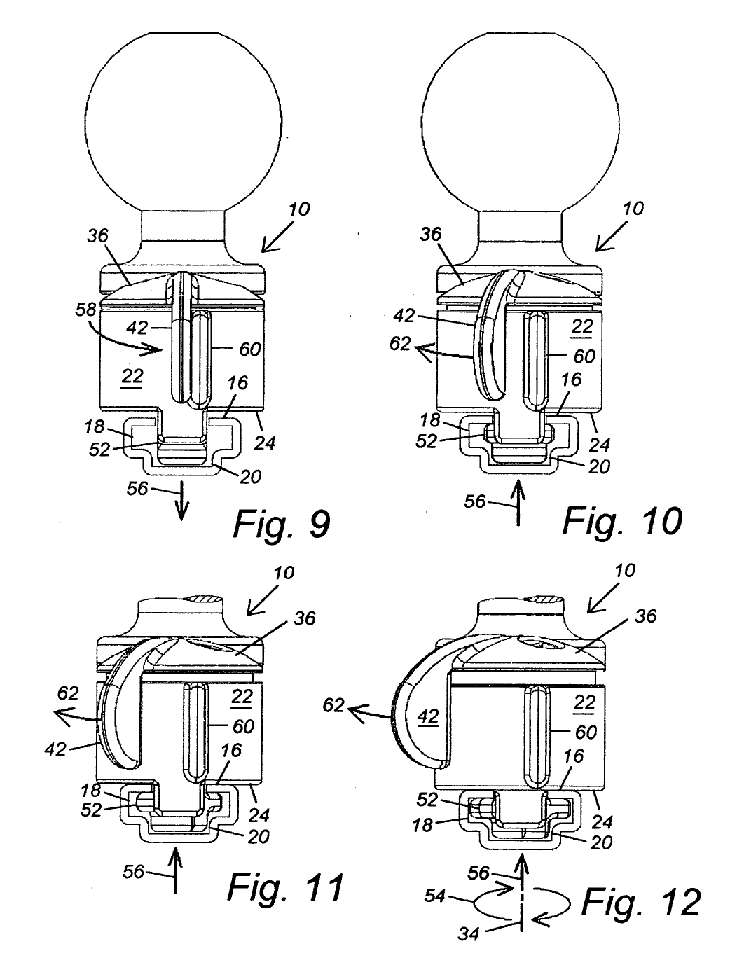

FIG. 9 shows T-clamp 10 configured in the installation state with flukes 52 of anchor 36 oriented in the undeployed installation configuration (shown) substantially aligned with between keel 28 and rudder 30 and spaced away from base 24 of T-clamp housing 22 along axis 34. This relative orientation of anchor 36 and flukes 52 is a function of the axial drive mechanism being rotated (arrow 58) about axis 34 toward the register 60, as by operation of grip 42 coupled thereto.

FIG. 10 and FIG. 11 show grip 42 being rotated (arrow 62) away from register 60 on T-clamp housing 22, whereby flukes 52 of anchor 36 are oriented in subsequent stages of deployment between the undeployed installation configuration (shown in FIG. 9) and a fully deployed interlock configuration (shown in FIG. 11).

FIG. 12 shows anchor 36 in its interlock configuration with its flukes 52 in a fully deployed interlock configuration oriented substantially crosswise of keel 28 and rudder 30 of T-clamp housing 22 and withdrawn into a position adjacent to its base 24. Anchor 36 is thereby rotated (arrow 54) about axis 34 and withdrawn linearly (arrow 56) substantially along axis 34 toward base 24 of T-clamp housing 22 such that flukes 52 are oriented in the fully deployed interlock configuration.

When anchor 36 in its interlock configuration with its flukes 52 in a fully deployed interlock configuration, T-clamp 10 is compressively interlocked with T-slot 12 with shank 50 of anchor 36 extended through opening 14 and flukes 52 extended into each of opposing T-arms 18. Accordingly, base 24 of T-clamp housing 22 is effectively compressed against T-slot mounting surface 16 adjacent to opening 14 of T-slot 12.

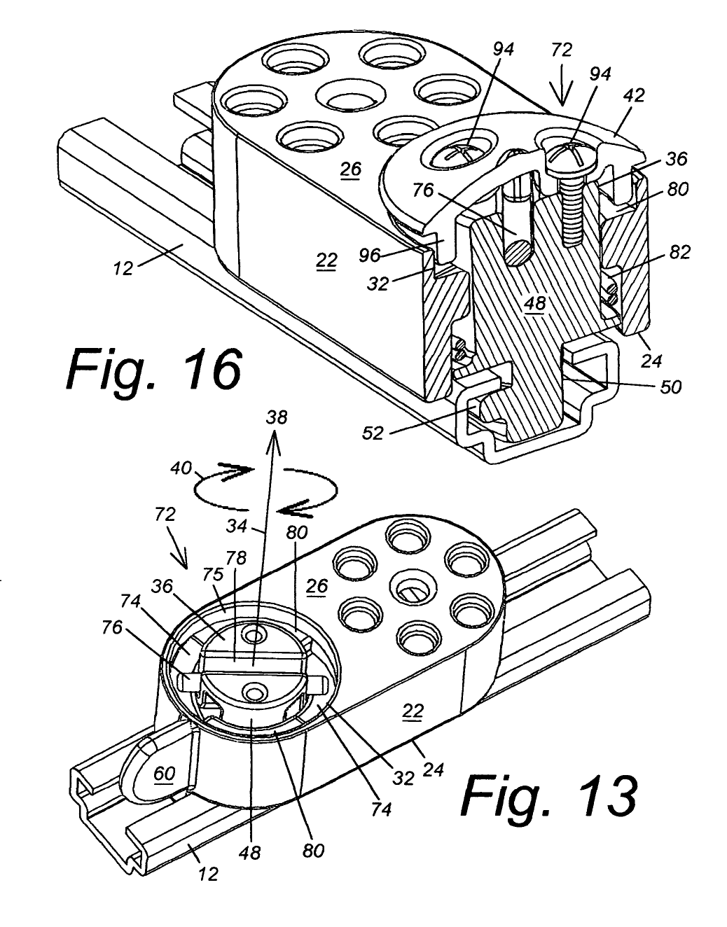

FIG. 13 shows T-clamp 10 with handle or other grip mechanism 42 removed to show stock portion 48 of anchor 36. An axial drive mechanism 72 is structured for driving rotational motion (arrow 54) of anchor 36 as disclosed herein. Axial drive mechanism 72 is formed of a rotational joint structured between stock portion 48 of anchor 36 and aperture 32 communicating between its base 24 and crown 26 of housing 22 along operational axis 34.

Axial drive mechanism 72 is operable for moving anchor 36 along operational axis 34 as a function of anchor 36 being rotated relative to T-clamp housing 22, whereby flukes 52 of anchor 36 are alternately movable between: i) the undeployed installation configuration, wherein flukes 52 are arranged substantially aligned between keel 28 and rudder 30 of housing 22 and spaced away from base 24 of housing 22, and ii) a deployed interlock configuration, wherein flukes 52 are oriented substantially crosswise of the keel and keel 28 and rudder 30 of housing 22 and adjacent to base 24 of housing 22.

As illustrated here, axial drive mechanism 72 includes a housing installation drive surface 74 structured as a pair of diametrically opposed spiral ramp surfaces formed on interior wall surface 75 of aperture 32 and aligned along operational axis 34 and inclined relative thereto. Axial drive mechanism 72 also includes an installation drive pin 76 fixed crosswise to anchor 36 and cooperating with spiral housing installation drive surfaces 74. For example, drive pin 76 is fitted into a slot 78 formed crosswise to anchor 36. Drive pin 76 is structured to interact with spiral housing installation drive surfaces 74 along operational axis 34.

Spiral drive surfaces 74 are molded or otherwise formed in T-clamp housing 22 within interior of aperture 32 and substantially aligned along operational axis 34. Stock portion 48 of anchor 36 is sized to rotate within aperture 32 of T-clamp housing 22 between spiral drive surfaces 74 and slide therebetween along axis 34. Drive pin 76 is fixed in stock 48 and extends beyond stock 48 to engage axial drive surfaces 74. Rotation (arrow 40) of anchor stock 48 causes drive pin 76 to move slidingly along inclined spiral axial drive surfaces 74 for moving (arrow 38) anchor 36 linearly upwardly along operational axis 34. Axial drive mechanism 72 includes handle or grip 42 for generating rotational motion (arrow 54) of anchor 36.

In operation, drive pin 76 is responsive to rotation (arrow 40) of anchor 36 for sliding upwardly (arrow 38) of operational axis 34 along cooperating pair of spirally inclined axial drive surfaces 74 and thereby causing flukes 52 of anchor 36 to move upwardly (arrow 38) along axis 34 from the undeployed installation configuration, wherein flukes 52 are arranged substantially aligned between keel 28 and rudder 30 of housing 22 and spaced away from base 24 of housing 22, and into the deployed interlock configuration, wherein flukes 52 are oriented substantially crosswise of the keel and keel 28 and rudder 30 of housing 22 adjacent to base 24 thereof and in forced contact with upper surface 18a of arm 18 of T-slot 12 of housing 22, whereby base 24 of T-clamp housing 22 is forced into contact with mounting surface 16 adjacent to T-slot opening 14.

Optionally, axial drive surfaces 74 are interrupted with anti-rotation “keeper” means 80 where drive pin 76 is retained in a rotated orientation. For example, the spiral drive surfaces 74 extend at their maximum elevation relative to an extension or “shelf” portion that is formed either level surfaces formed substantially perpendicular to operational axis 34, or canted at a slightly negative inclination relative to respective spiral drive surfaces 74.

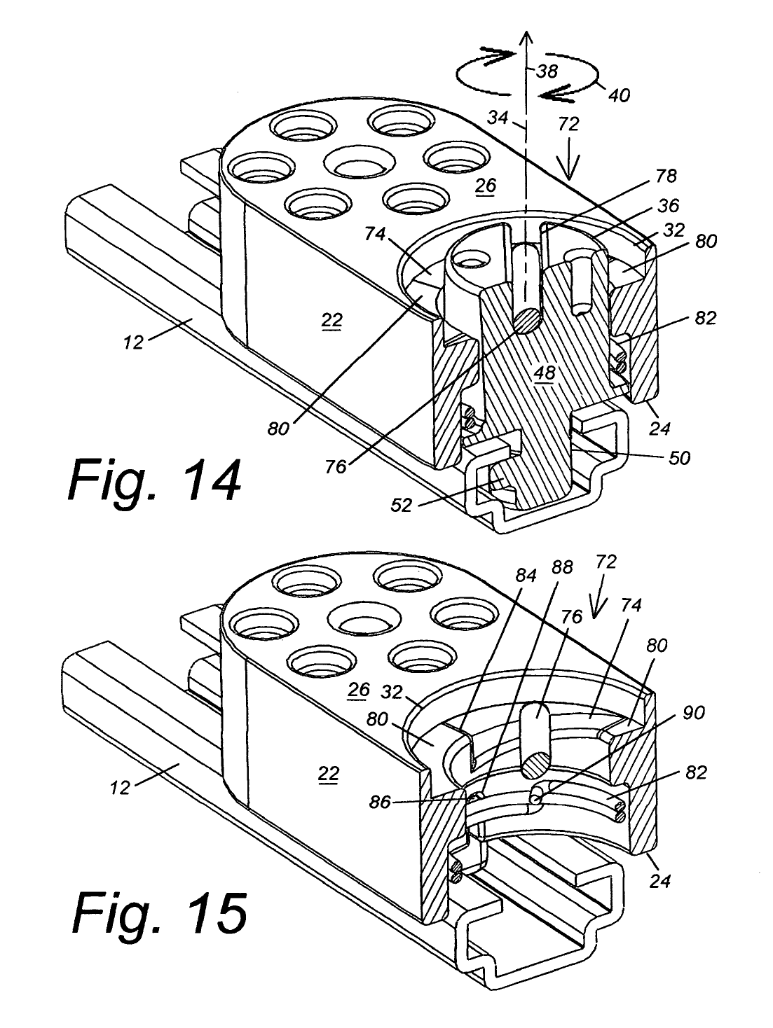

FIG. 14 shows cross-section of T-clamp housing 22 and axial drive mechanism 72 taken along operational axis 34 through anchor 36. Optionally, axial drive mechanism 72 further includes a rotational biasing member 82 for urging anchor 36 into rotation (arrow 40) about axis operational 34 for sliding rotation drive pin 76 upwardly away from mounting surface 16 of T-slot 12 along cooperating pair of spirally inclined axial drive surfaces 74. Biased rotation (arrow 40) of anchor 36 about axis 34 thereby moves anchor 36 linearly upwardly (arrow 38) along axis 34 from the undeployed installation configuration into the deployed interlock configuration. For example, rotational biasing member 82 is a coiled spring configured for torsional urging of anchor 36 in rotation (arrow 40) about operational axis 34. Accordingly, rotational biasing member 82 is torsionally coupled between anchor 36 and aperture 32 of housing 22 for substantially automatically rotating anchor 36 from the undeployed installation configuration thereof toward the deployed interlock configuration.

FIG. 15 shows cross-section of T-clamp housing 22 and axial drive mechanism 72 having anchor 36 removed for more clearly illustrating inclined spiral axial drive surfaces 74. Optionally, axial drive mechanism 72 includes a stop or brake 84 at its lower extreme for limiting angular motion of drive pin 76 relative to T-clamp housing 22. Brake 84 thereby limits rotation of anchor 36 for arranging flukes 52 in the undeployed installation configuration substantially aligned between keel 28 and rudder 30 of housing 22, whereby T-clamp 10 is configured for installation into or removal from T-slot 12.

Here, coiled spring rotational biasing member 82 is formed with an outward tang 86 positioned for mating with a cooperating slot 88 in aperture 32 of T-clamp housing 22. An inward tang 90 is positioned for mating with a cooperating slot 92 in stock 48 of anchor 36.

FIG. 16 shows axial drive mechanism 72 including handle or other grip mechanism 42 coupled to stock portion 48 of anchor 36. For example, one or a pair of screws 94 are threaded into anchor stock 48 for securing grip 42, which also operates to secure drive pin 76 in slot 78. Grip 42 optionally includes a skirt 96 sized to loosely engage aperture 32 for centering grip 42 therein.

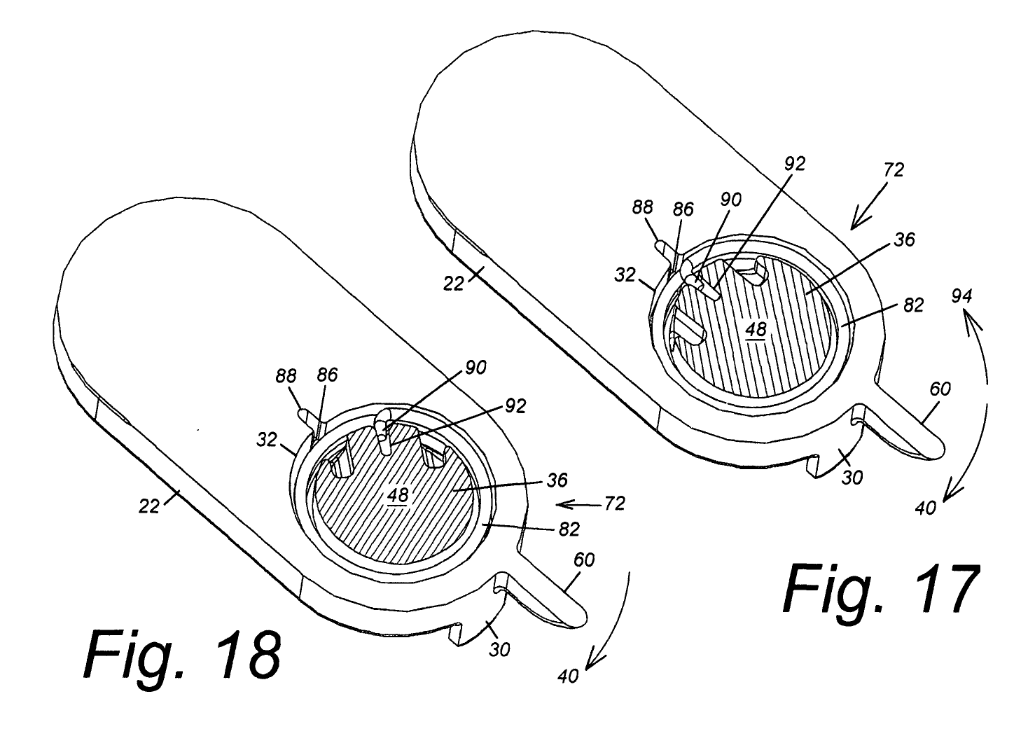

FIG. 17 shows cross-section of T-clamp housing 22 and axial drive mechanism 72 taken crosswise of axis 34 through anchor 36. Here, anchor 36 is twisted (arrow 94) about axis 34 against installation rotation (arrow 40) for sliding rotation drive pin 76 downwardly toward mounting surface 16 of T-slot 12 along cooperating pair of spirally inclined axial drive surfaces 74, and thereby moving anchor 36 linearly downwardly (arrow 38) along axis 34 away from the deployed interlock configuration into the undeployed installation configuration (shown). Such twisting against installation rotation (arrow 40) thus winds torsional rotational biasing member 82 into a coiled state for urging anchor 36 into rotation (arrow 40) about axis 34 upon release.

FIG. 18 shows anchor 36 rotated about operational axis 34 along installation rotation (arrow 40) for sliding rotation drive pin 76 upwardly away from mounting surface 16 of T-slot 12 along cooperating pair of spirally inclined axial drive surfaces 74. Anchor 36 is thereby moved linearly upwardly (arrow 38) along operational axis 34 away from the undeployed installation configuration into the deployed interlock configuration (shown). Such installation rotation (arrow 40) of anchor 36 about operational axis 34 is responsive to torsional unwinding of rotational biasing member 82 from its coiled state.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. A twist-lock T-clamp, comprising:
a substantially rigid housing comprising a base and a crown, the housing further comprising a keel projected from the base of the housing, and an aperture formed between the base and the crown along an operational axis;
a rigid anchor that is movable relative to the operational axis, the anchor comprising a shank projected outwardly of the base of the housing, and a pair of opposing flukes adjacent to one end of the shank and extended laterally outwardly therefrom; and
a drive mechanism coupled between the anchor and the aperture of the housing, the drive mechanism being operable for moving the anchor along the operational axis between:
an installation configuration wherein the flukes of the anchor are substantially aligned with the keel and spaced outwardly away from the base of the housing, and
an interlock configuration wherein the flukes of the anchor are substantially crosswise of the keel and positioned adjacent to the base of the housing.

2. The T-clamp of claim 1, wherein the drive mechanism further comprises a rotational biasing member urging anchor between the installation configuration and the interlock configuration.

3. The T-clamp of claim 1, wherein the drive mechanism further comprises a grip coupled thereto for moving the flukes of the anchor between the interlock configuration and the installation configuration.

4. The T-clamp of claim 1, wherein one or more of the flukes further comprises a surface that is rotated about a fluke axis oriented substantially crosswise of the operational axis.

5. The T-clamp of claim 1, wherein the drive mechanism further comprises an axial drive mechanism having a spiral drive surface aligned with the operational axis and inclined relative thereto, and a drive pin fixed crosswise to anchor and cooperating with the spiral drive surface for moving the anchor substantially along the operational axis.

6. The T-clamp of claim 1, wherein the drive mechanism is further responsive to a rotation of the anchor partially about the operational axis for moving the anchor substantially linearly along the operational axis.

7. The T-clamp of claim 6, wherein the rotation of the anchor partially about the operational axis further comprises a rotation of the shank partially about the operational axis for moving the anchor between the installation configuration wherein the flukes are substantially aligned with the keel, and the interlock configuration wherein the flukes are substantially crosswise of the keel; and
wherein moving the anchor substantially linearly along the operational axis further comprises moving the anchor between the installation configuration wherein the flukes are spaced outwardly away from the base of the housing, and the interlock configuration wherein the flukes are positioned adjacent to the base of the housing.

8. The T-clamp of claim 1, wherein the housing further comprises a rudder projected from the base thereof in a position spaced away from the keel with the aperture therebetween.

9. A twist-lock T-clamp, comprising:
a) a substantially rigid housing, comprising a substantially planar base and a crown spaced away therefrom, the housing further comprising:
i) a keel formed along the base of the housing and sized to be received into a T-slot,
ii) a rudder formed on the base of the housing in a position spaced away from the keel and sized to be received into the T-slot,
iii) an aperture positioned between the keel and the rudder and communicating between the base and the crown of the housing along an operational axis oriented substantially perpendicularly to the base;
b) a substantially rigid anchor coupled for motion along the operational axis, the anchor further comprising a shank projected externally of the base of the housing adjacent to the keel thereof and a pair of flukes extended laterally outwardly of the shank adjacent to one end thereof in substantially diametrically opposed positions, the anchor being movable in a rotational manner about the operational axis and linearly there along for moving the flukes relatively toward and away from the base of the housing as a function of the motion of the anchor along the operational axis, each of the flukes being further sized to be received into the T-slot;
c) a rotational joint structured between the anchor and the aperture of the housing and being operable for moving the anchor along the operational axis as a function of the anchor being rotated relative to the housing, whereby each of the flukes of the anchor is alternately movable between: i) a T-slot installation configuration substantially aligned between the keel and the rudder of the housing and spaced outwardly away from the base thereof, and ii) a T-slot interlock configuration oriented angularly of the keel and the rudder of the housing and positioned adjacent to the base thereof; and
d) a biasing member coupled between the anchor and the housing for substantially automatically rotating the anchor away from the installation configuration thereof toward the interlock configuration.

10. The T-clamp of claim 9, wherein the biasing member further comprises a torsion spring having a first tang coupled to a cooperating slot in the aperture of the housing, and a second tang coupled to a cooperating slot in the anchor.

11. The T-clamp of claim 9, further comprising a grip coupled to the anchor for applying a rotational force oppositely of the biasing member for rotating the anchor away from the interlock configuration thereof toward the installation configuration.

12. The T-clamp of claim 9, wherein each of the flukes is formed along a fluke axis oriented substantially crosswise of the operational axis, and one or more of the flukes further comprises a surface facing toward the base of the housing and rotated about the fluke axis thereof.

13. The T-clamp of claim 9, wherein the aperture of the housing further comprises a pair of spiral axial drive surfaces that are inclined relative to operational axis, and the anchor further comprises a drive pin fixed crosswise thereto, and the drive pin cooperates with the spiral axial drive surfaces for moving the anchor linearly along the operational axis.

14. The T-clamp of claim 9, wherein the housing further comprises a register positioned for registering the anchor with the flukes in the T-slot installation configuration thereof.

15. The T-clamp of claim 9, further comprises an anti-rotation means for retaining the flukes of the anchor in the T-slot installation configuration thereof.

16. A twist-lock T-clamp, comprising:
a) a substantially rigid housing, comprising a substantially planar base, a keel formed along the base, and a crown spaced away therefrom with an aperture communicating between the base and the crown adjacent to the keel, the housing further comprising a plurality of spiral installation drive surfaces formed on an interior wall surface of the aperture and aligned along an operational axis oriented substantially perpendicular of the base;
b) a twist-lock anchor resident within the aperture in the housing, the anchor comprising a stock portion moveable within the aperture between the spiral installation drive surfaces formed therein, and further comprising a shank extended from the stock portion substantially along the operational axis, and two flukes adjacent to one end of the shank and rigidly extended laterally outwardly thereof substantially crosswise of the operational axis, wherein the flukes and at least a portion of the shank of the anchor are positioned externally of the base of the housing adjacent to the keel thereof;
c) an installation drive pin coupled to the stock portion of the anchor substantially crosswise of the operational axis and being sized to fit within the interior wall surface of the housing aperture, the drive pin being positioned to interact with the spiral installation drive surfaces of the housing aperture; and
d) a biasing member coupled for imparting an interlock rotation of the anchor about the operational axis for rotating the anchor away from an undeployed installation configuration having the flukes thereof configured in an installation orientation substantially parallel with the keel, and toward a deployed interlock configuration having the flukes configured in an interlock orientation substantially crosswise of the keel, the interlock rotation further moving the installation drive pin along the spiral installation drive surfaces of the housing aperture for drawing the flukes linearly along the operational axis away from an installation position spaced outwardly away from the base of the housing toward an interlock position spaced adjacent to the base of the housing; and
e) a grip coupled to the anchor for a imparting an installation rotation of the anchor about the operational axis, the installation rotation rotating the anchor away from the deployed interlock configuration having the flukes configured in the interlock orientation thereof, and toward the undeployed installation configuration having the flukes configured in the installation orientation thereof.

17. The T-clamp of claim 16, wherein the spiral installation drive surfaces further comprise a pair of inclined ramps formed on the interior wall surface of the housing aperture substantially diametrically opposed across the operational axis.

18. The T-clamp of claim 17, wherein the biasing member further comprises a torsional spring coupled between the anchor and the interior wall surface of the housing aperture.

19. The T-clamp of claim 16, further comprising a register formed on the housing in a position for arresting the installation rotation of the anchor the undeployed installation configuration thereof having the flukes configured in the installation orientation.

20. The T-clamp of claim 16, wherein at least one of the flukes further comprises a pitched upper interlock surface facing toward the housing base, the interlock surface being rotated at a small ramp angle about a fluke axis that is oriented substantially crosswise of operational axis.
